(19) United States
(12) Patent Application Publication
(10) Pub. No.: US 2015/0152586 A1
(43) Pub. Date: Jun. 4, 2015

(54) ACTUATING DEVICE FOR THE HYDRAULIC DISTRIBUTOR OF A WASHING MACHINE

(71) Applicant: ELBI International S.p.A., Torino (IT)

(72) Inventors: Michele Farano, Collegno (TO) (IT); Paolo Da Pont, Torino (IT); Paolo Ravedati, Moncalieri (TO) (IT); Marco Simondi, Torino (IT)

(21) Appl. No.: 14/410,981

(22) PCT Filed: Jun. 21, 2013
(86) PCT No.: PCT/IB2013/055093

§ 371 Date: Dec. 23, 2014

(30) Foreign Application Priority Data
Jun. 25, 2012 (IT) TO2012A000556

(51) Int. Cl. D06F 39/02; F16K 31/52; D06F 39/08

(52) U.S. Cl. CPC D06F 39/028; D06F 39/083; F16K 31/52

(57) ABSTRACT

Actuating device (10) for a laundry washing machine (M) includes a casing (12), a driver (14), which is contained in the casing (12), a control mechanism (16), which is actuated by the driver (14) to assume a plurality of arrangements, in which it is able to bring a shutter (N) of a hydraulic distributor (D) to different operating conditions. A rotatory element (18), which, during its rotation, is supported by the casing (12) and is actuated by said driver (14). The angular position of the rotatory element (18) indicates the arrangement assumed by the driver (14). A sensor (20) is adapted to detect the angular position assumed by the rotatory element (18), and the casing (12) has a through opening (22), through which the control mechanism (16) is connected to the rotatory element (18).

### TECHNICAL FIELD

The present invention is relative to an actuating device, in particular for a hydraulic distributor in a washing machine, such as a laundry washing machine.

### TECHNOLOGICAL BACKGROUND

In the field of washing machines, and in particular in the field of laundry washing machines, the use of hydraulic distributors is known, which are controlled by actuating devices, so that the distributors assume different conditions or arrangements, in which they control the delivery of the liquid in the washing tanks, in predetermined operating modes, as a function of the different phases of a washing cycle.

In particular, the delivery of liquid is selectively controlled so as to perform the distribution of a washing agent or of the washing agents available in the compartments of a drawer, inside the washing tub and during a washing cycle, also as a function of the washing programs that have been preselected by the user.

### SUMMARY OF THE INVENTION

The object of the present invention is to provide an improved actuating device, which, at the same type, can be produced in a simple and economic fashion.

According to the present invention, this and other objects are reached by means of an actuating device according to appended claim 1.

The appended claims are an integral part of the technical teachings provided in the following description concerning the present invention.

### BRIEF DESCRIPTION OF THE DRAWINGS

Further features and advantages of the present invention will be best understood upon perusal of the following detailed description, which is provided by way of example and is not limiting, with reference to the accompanying drawings, which specifically show what follows:

FIG. 1 is a schematic view of a washing machine, which comprises an explanatory embodiment of an actuating device according to the present invention;

FIG. 2 is a partial plan view from the top of an assembly comprising a distributor and the actuating device included in the washing machine of FIG. 1;

FIG. 3 is a partial section view of the assembly shown in FIG. 2;

FIG. 4 shows an exploded prospective view from the top of the actuating device shown in the previous figures;

FIG. 5 shows an enlarged partial view of a detail of the actuating device shown in FIG. 4; and

FIG. 6 shows a plan view from the top of the actuating device shown in the previous figures.

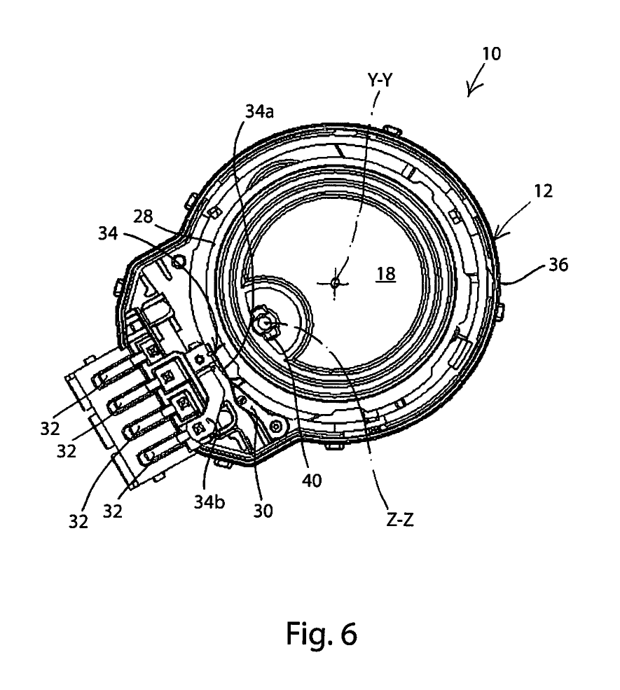

### DETAILED DESCRIPTION OF THE INVENTION

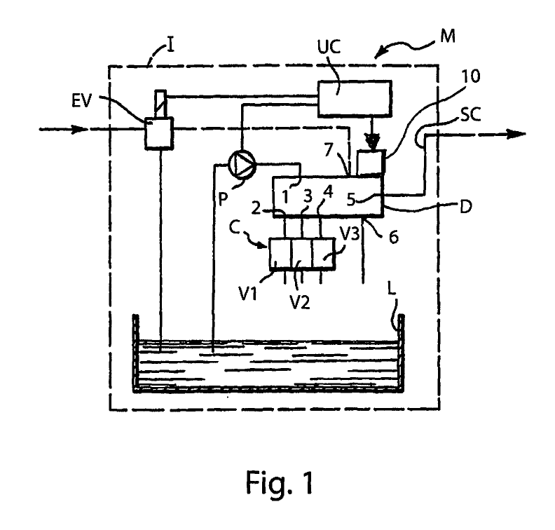

With reference to FIG. 1, M indicates, as a whole, a non-limiting embodiment of a washing machine, in particular a laundry washing machine. Machine M comprises a casing I, in which a washing chamber or tub L is defined.

According to the example shown in FIG. 1, washing machine M comprises, furthermore, a solenoid valve EV, which is mounted in casing I and is adapted to control the delivery of water from the water distribution network to washing chamber or tub L. Machine M has, furthermore, a draining duct SC, which is adapted to allow the liquid to be emptied out of washing chamber L.

According to the example shown in FIG. 1, the washing machine comprises furthermore, an electric pump P, which can be activated so as to draw water from the washing chamber or tub L, and a hydraulic distributor D having a first inlet that is connected to the outlet or delivery of pump P. Furthermore, hydraulic distributor D has a plurality of outlets 2, 3, 4, which communicate with corresponding compartments V1, V2, V3 of a container or drawer C, adapted to house respective quantities of washing agents. Distributor D can have further outlets 5 and 6, which respectively communicate in a direct manner with draining duct SC and with washing chamber L. Furthermore, distributor D can also have a further inlet 7, which is connected to solenoid valve EV.

According to the example shown in FIG. 1, washing machine M comprises an explanatory embodiment of an actuating device 10 according to the present invention. Actuating device 10 is associated with distributor D, so as to control, during the operation of washing machine M, the liquid flow inside distributor D between inlet (or inlets) 1, 7 and outlets 2-6, according to predetermined operating modes. As a person skilled in the art can clearly understand, hydraulic distributor D and its structure of inlets and outlets 1-7 are described as a mere way of example, since actuating device 10 described and shown herein is also able to be coupled to different hydraulic distributor structures.

Furthermore, in the example shown in FIG. 1, washing machine M also comprises a control unit UC, adapted to control the overall operation of the machine. Control unit UC can be electric or electronic and is adapted to control, in particular, the operation of solenoid valve EV, of pump P, of distributor D through actuating device 10, and also of other devices of the washing machine that are not shown for the sake of simplicity.

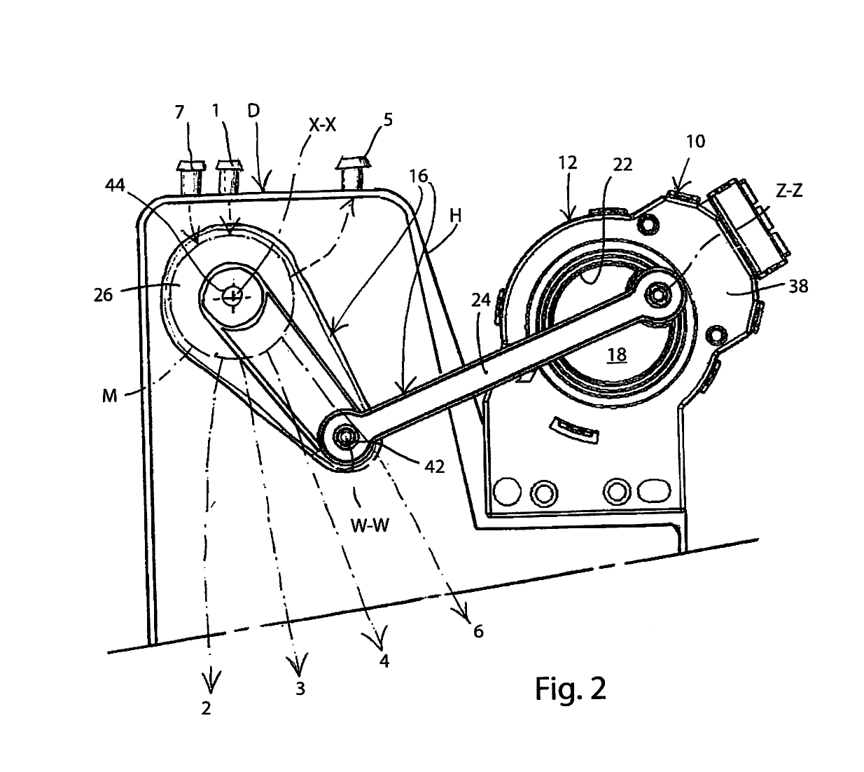

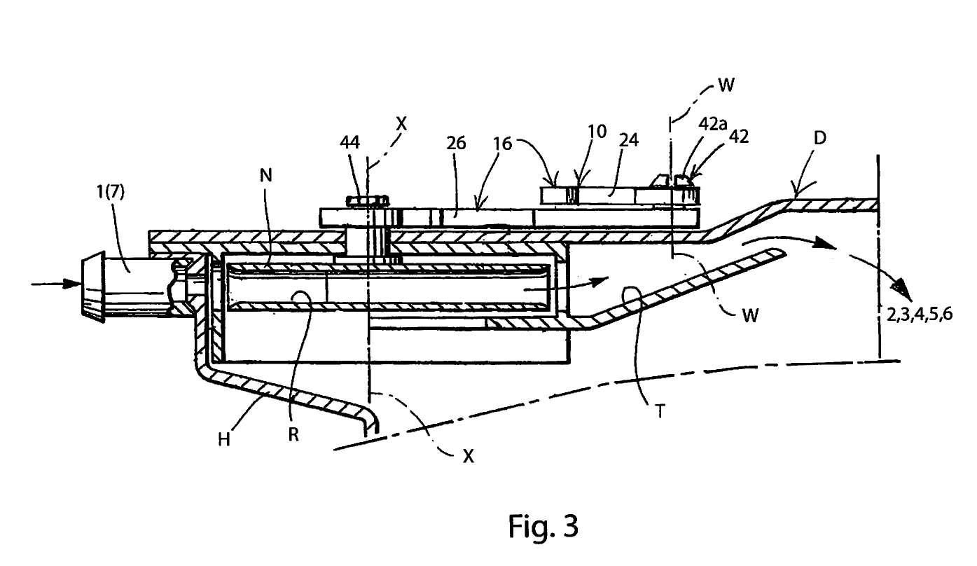

With reference to FIGS. 2 and 3, an assembly is shown, which comprises distributor D and actuating device 10, which are mechanically connected to one another.

FIG. 3 shows some inner details of the example of distributor D shown. As it is widely known in the technical field, distributor D comprises a hollow body H, to which inlet (or inlets) 1, 7 lead and from which outlets 2-6 start, and a rotatory shutter organ N, which acts as the actual distributor organ, which is supported in a rotatory manner by hollow body H and is able to assume a plurality of different angular positions, in each of which shutter N is adapted to convey the liquid flow coming from at least one of inlets 1, 7 towards at least one of outlets 2-6, according to predetermined operating conditions. In the example shown, in each one of said angular positions, distributor organ N is able to selectively establish a fluid flow between at least one of inlets 1, 7 and a single one of outlets 2-6 according to predetermined operating modes.

In the example shown, distributor organ N can rotate around a fixed rotation axis X-X (FIG. 3) with respect to the plan view shown in FIG. 2. Distributor organ N has a substantially discoidal shape, for example a circular shape, and has a plurality of ducts R (of which only one is shown in FIG. 3) in a substantially radial arrangement, which extend through it and are adapted to establish a fluid communication between inlets 1, 7 and outlets 2-6, preferably in a selective manner, through channels T (of which only one is shown in FIG. 3 and which are represented with a dash-dot line in FIG. 2), which are obtained inside hollow body H and properly face ducts R. For example, said channels can follow a substantially radial arrangement so as to correspond to the position of ducts R.

In particular, when distributor organ N is caused to rotate around axis X-X, ducts R assume different orientations on the rotation plane and selectively allow the flow of fluid between desired inlet (or inlets) 1, 7 and the predetermined outlet (or outlets) 2-6 through corresponding channel/s T.

Further technical features concerning a distributor D of the type described above are described in the Italian Patent Application no. TO1992A000864.

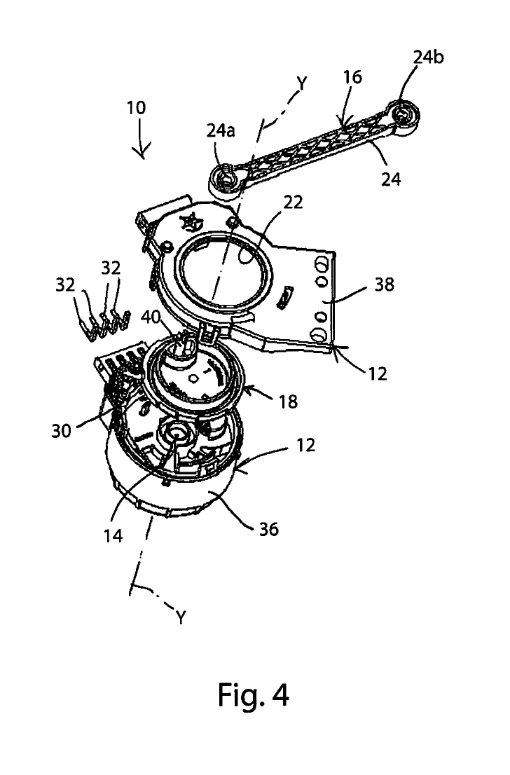

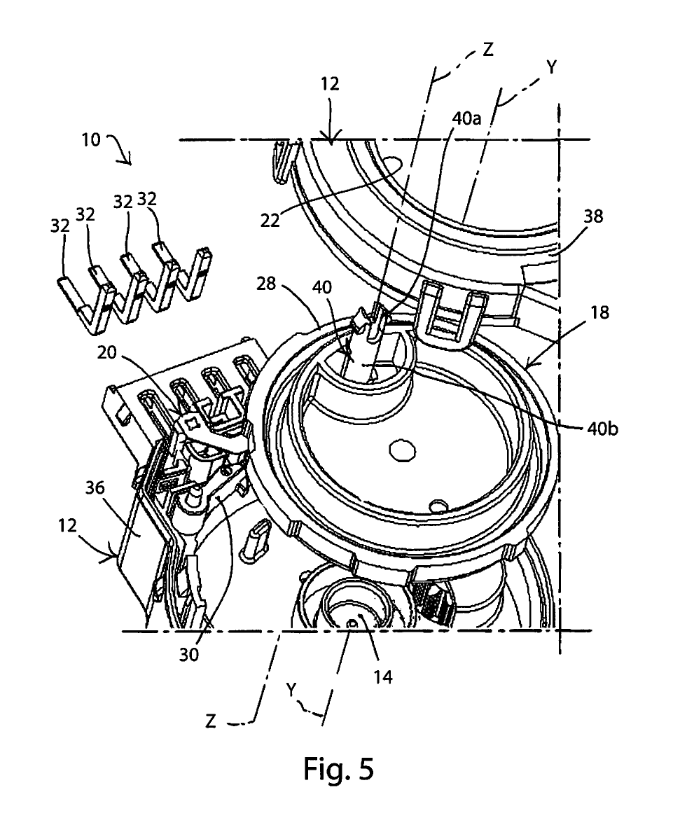

Actuating device 10 comprises a casing 12, driving means, which are contained in casing 12 and are indicated, as a whole, with number 14 (they are shown in particular in FIGS. 4 and 5), a control mechanism 16, which is actuated by means of driving means 14, so as to assume a plurality of arrangements, in which it brings shutter or distributor organ N to different operating conditions. Actuating device 10 comprises, furthermore, a rotatory element 18, which is supported during its rotation by casing 12 and is actuated during its rotation by driving means 14, the angular position of rotatory element 18 indicating the angular position assumed by driving means 14 and, thus, the arrangement assumed by control mechanism 16. Furthermore, actuating device 10 comprises sensor means 20, which are adapted to detect the angular position assumed by control mechanism 16 (and to transmit it to control unit UC).

Casing 12 has a through opening 22, through which control mechanism 16 is connected to rotatory element 18.

Preferably, control mechanism 16 is connected to rotatory element 18 in an eccentric position of the latter, namely in a position that is radially spaced apart with respect to fixed rotation axis Y-Y of rotatory element 18. In the embodiment shown, the connection between control mechanism 16 and rotatory element 18 takes place in correspondence to a mobile articulation axis Z-Z, which is integral to rotatory element 18 and is spaced apart from fixed rotation axis Y-Y.

Preferably, the control mechanism is a knee-like mechanism 16, in other words a mechanism of the connecting rod-crank type, which is connected between rotatory element and shutter N. In particular, knee-like mechanism 16 comprises a pair of organs that are pivotable around fixed rotation axis X-X of shutter N and, respectively, around mobile articulation axis Z-Z supported by rotatory element 18; said pivotable organs, furthermore, are articulated to one another in correspondence to a mobile articulation axis W-W (see in particular FIGS. 2 and 3). In the example shown, the rotation range of said pivotable organs lies on a plane that is substantially perpendicular to the axes mentioned above.

In the embodiment shown, control mechanism 16 comprises:

a connecting rod member 24, which is articulated, on one side, in correspondence to rotatory element 18, for example around mobile rotation axis Z-Z; and

a crank member 26, which is articulated, on one side, in correspondence to connecting rod member 24, for example around mobile articulation axis W-W, and on the other side can be connected to shutter N, for example in correspondence to a fixed rotation axis, preferably coinciding with rotation axis X-X of shutter N.

Preferably, connecting rod member 24 is directly articulated to rotatory element 18 in correspondence to an eccentric portion of the latter.

Advantageously, connecting rod member 24 is directly articulated to rotatory element 18.

Preferably, sensor means 20 comprises a cam profile 28, which is peripherally supported by rotatory element 18, and a feeler pin member 30, which is able to follow cam profile 28, so that sensor means 20 detect the position assumed by driving means 14, for example by providing, as an output, a position signal as a function of the position of feeler pin member 30 on cam profile 28. In the embodiment shown, feeler pin member 30 is mounted so as to pivot on casing 12 and is adapted to be pushed by cam profile 28 of rotatory organ 18 as a function of the angular position assumed by driving means 14 (and consequently by shutter N through control mechanism 20). As a skilled person knows, in order to transmit signals indicating the angular position assumed by driving means 14, feeler pin organ 30 cooperates with a control switch, indicated as a whole with number 34, which is connected in a known manner to one or more contacts 32 provided on actuating device 10. Control switch 34 is suited to cause the closing and the opening of an electric control circuit, in predetermined operating conditions, through one or more of said contacts 32; said electric control circuit can be connected to and/or associated with control unit UC, so as to provide signals indicating the attitude assumed by driving means 14 (and consequently by shutter N through control mechanism 20). For example, control switch 34 can comprise a flexible plate 34a, which is connected to one or more contacts 32 and is adapted to be pushed by feeler pin 30 with an approaching or departing movement with respect to a fixed plate 34b, which is also connected to one or more of said contacts 32, so as to respectively cause the closing or the opening of the electric control circuit.

In the embodiment shown, one or more of said contacts 32 are connected, on one side, to driving means 12 and, on the other side, they can be connected to a power circuit, which is able to provide an electric potential that is suited to control driving means 12; said electric power circuit can be powered up in a controlled manner through control unit UC, for example as a function of the signals coming from sensor means 20 and indicating the angular position assumed by driving means 14.

As a person skilled in the art can understand, the structure and the arrangement of the plurality of contacts 32 are known and, therefore, do not require a detailed description.

Preferably, casing 12 comprises a half-shell or hollow cup 36, adapted to house driving means 14 and rotatory element 18, and a lid 38, which is provided with opening 22 and is adapted to axially close half-shell 36. In the embodiment shown, half-shell or hollow cup 36 defines, on the inside, a cavity with a substantially cylindrical shape. Furthermore, lid 38 is adapted to be connected to hollow body H, for example by being screwed thereto.

Preferably, driving means 14 comprise an electric motor and a transmission (not numbered), such as a gear, which cooperates with the electric motor; in the embodiment shown, the electric motor and the transmission build a reduction gear assembly, which, as an output, is able to cause rotatory element 18 to rotate around its own fixed rotation axis Y-Y.

Preferably, rotatory element 18 substantially has the shape of a disc, on which there is peripherally obtained an alternated sequence of recesses and projections, which creates cam profile 28 cooperating with feeler pin 30 to appropriately interrupt the electric control circuit. In particular, said rotatory element 18 is rigidly connected to the output of driving means 14.

Preferably, connecting rod element 24 is an oblong body or a beam-shaped body, which is articulated, on one side, with a pin 40, which is supported by rotatory element 18, for example in an eccentric position (with respect to rotation axis Y-Y), and extends through through opening 22. In the embodiment shown, connecting rod member 24 can be coupled to pin 40 in an interlocking manner. In particular, pin 40 has a wide head 40a that can be elastically spread apart, namely, for example, comprises two lateral appendages that can be spread apart from one another and are able to extend through and beyond a corresponding hole 24a obtained through connecting rod member 24. When said hole 24a extends beyond the wide head, it is in correspondence to a narrow portion 40b of pin 40, with which it is coupled with freedom of rotation. In the embodiment shown, the position of pin 40 coincides with the position of axis Z-Z.

Preferably, crank member 26 is a rotatory body supporting a pin 42, to which connecting rod member 24 is articulated, for example in an eccentric position (with respect to rotation axis X-X). In the embodiment shown, connecting rod member 24 can be coupled to pin 40 in an interlocking manner. In particular, pin 42 has a wide head 42a that can be elastically spread apart and is able to extend through and beyond a corresponding hole 24b obtained through the connecting rod member 24. Advantageously, the structure and the shape of pin 42, in particular of wide head 42a and of hole 24b, can be substantially similar to those of pin 40 and of hole 24b. In the embodiment shown, the position of pin 42 coincides with the position of axis W-W.

Preferably, crank member 26 is fitted in correspondence to rotation axis X-X of shutter N, so as to create a rigid coupling between crank member 26 and shutter N. In the embodiment shown, shutter N has a central stem 44, which projects through hollow body H and on which the crank member is fitted 26. In any case, crank member 26 is only preferably mounted so as to rotate around a fixed rotation axis coinciding with rotation axis X-X of shutter N; as a matter of fact, in further embodiments, crank member 26 can be mounted so as to rotate around a different fixed rotation axis and can be connected to shutter N only in an indirect fashion, for example by cooperating with it by means of the interposition of further transmission means (such as assemblies made up of gear wheels meshing with one another), so as to control a rotation of said shutter N around rotation axis X-X.

Naturally, the principle of the present invention being set forth, the embodiments and the implementation details can be widely changed with respect to what described above and shown in the drawings as a mere way of non-limiting example, without in this way going beyond the scope of protection provided by the accompanying claims.

1. Actuating device for a hydraulic distributor in a laundry washing machine; said device comprising:
a casing;
driving means contained in said casing;
a control mechanism, actuated by said driving means to assume a plurality of arrangements, in which the control mechanism is able to bring a shutter of said hydraulic distributor to different operating conditions;
a rotary element, supported during its rotation by said casing and actuated during rotation by said driving means; an angular position of said rotary element indicating the arrangement assumed by said driving means; and
sensor means, for detecting the angular position assumed by said rotatory element;
said casing having a through opening, through which the control mechanism is connected to said rotary element.

2. Actuating device according to claim 1, wherein said control mechanism is connected to said rotary element in an eccentric position of the latter rotary element.

3. The device according to claim 1, wherein said control mechanism is a mechanism of the connecting rod-crank type, which is connected, on one side, to said rotary element and can be connected, on the other side, to said shutter.

4. The device according to claim 3, wherein said control mechanism comprises:
a connecting rod member, articulated on one side in correspondence to said rotatory rotary element; and
a crank member, articulated on one side in correspondence to said connecting rod member and on the other side can be connected to or can cooperate with said shutter.

5. The device according to claim 4, wherein said connecting rod member is articulated to said rotary element in correspondence to a mobile articulation axis, which is eccentric with respect to the fixed rotation axis of said rotary element.

6. The device according to claim 4, wherein said crank member is adapted to be mounted so as to rotate around a fixed rotation axis.

7. The device according to claim 4, wherein said crank member is articulated to said connecting rod member in correspondence to a mobile articulation axis, which is eccentric with respect to the fixed rotation axis of said crank member.

8. The device according to claim 1, wherein said sensor means comprise:
a cam profile, supported by said rotary element; and
a feeler pin member, which is able to follow said cam profile, so that said sensor means detect the position of said driving means.

9. Hydraulic distributor for laundry washing machines, comprising a device according to claim 1.

10. Washing machine comprising a hydraulic distributor according to claim 9.
